(19) United States
(12) Patent Application Publication
(10) Pub. No.: US 2015/0079483 A1
(43) Pub. Date: Mar. 19, 2015

(54) OXIRANE-BASED ADDITIVES IN SUPPORT OF FIVE VOLT LITHIUM ION CHEMISTRY

(71) Applicants: Arthur von Wald Cresce, Silver Spring, MD (US); Kang Conrad Xu, North Potomac, MD (US)

(72) Inventors: Arthur von Wald Cresce, Silver Spring, MD (US); Kang Conrad Xu, North Potomac, MD (US)

(73) Assignee: U.S. Government as represented by the Secretary of the Army, Adelphi, MD (US)

(21) Appl. No.: 14/027,268

(22) Filed: Sep. 16, 2013

(51) Int. Cl. H01M 10/0567; H01M 10/0525

(52) U.S. Cl. CPC H01M 10/0567; H01M 10/0525
USPC 429/338; 429/188; 429/342; 429/337; 429/341; 429/336; 429/340; 429/339; 429/200

(57) ABSTRACT

The present disclosure relates to several families of commercially available oxirane compounds that can be used as electrolyte co-solvents, solutes, or additives in non-aqueous electrolyte and their test results in various electrochemical devices. The presence of these compounds can enable rechargeable chemistries at high voltages. These compounds were chosen for their beneficial effect on the interphasial chemistries that occur at high potentials on the classes of 5.0V cathodes used in experimental Li-ion systems.

### BACKGROUND

1. Field of Use

The present disclosure relates to electrolytes having enhanced electrochemical stability, particularly for use supporting Li-ion chemistries that occur near or above 5.0 V.

2. Description

Li ion chemistry is established upon reversible intercalation/de-intercalation of Li ion into/from host compounds. The voltage of such an electrochemical device is determined by the chemical natures of anode and cathode, where Li ion is accommodated or released at low potentials in the anode, and at high potentials in the cathode. The reversibility of the cell chemistry and the resultant energy density are limited by the stability of the electrolyte to withstand the reductive and oxidative potentials of these electrodes. In today's market, a majority of Li ion batteries use organic carbonate as electrolyte solvents, which decompose oxidatively above 4.5 V vs. Li, and set an upper limit to the candidate cathode chemistry. Despite the fact that 5 V Li ion chemistry has already been made available from such cathodes like olivine structured LiCoPO₄ (˜5.1 V) and spinel structured LiNi_{0.5}Mn_{1.5}O₄ (˜4.7 V), their advantages such as high energy density and quality cannot be realized due to the lack of an electrolyte that is able to withstand high voltage operation.

Under high voltages, the electrolyte in the electrochemical cell decomposes and is unstable. During operation, a relative thin film or layer forms at the surface boundary of the cathode and the anode. Ions passivate through both the liquid electrolyte and the semi-solid film layer. Over time, this layer deteriorates or grows as the liquid portion decomposes. Increased voltage causes both the solid and liquid phase of the electrolyte to decompose at a rapid rate causing fewer cycles achievable by a given electrochemical cell.

Improvements were made on mitigating the oxidizing nature on the cathode surfaces through surface coating approaches, and various metal oxides or phosphates were shown to be effective in elongating the service life of the carbonate-based electrolytes (J. Liu, et al, Chem. Mater, 2009, Vol. 21, 1695). But these coating approaches have their own intrinsic shortcomings as well. They not only add additional cost to the manufacturing of the cathode materials, but also induce further interphasial resistance to the Li ion migration at electrolyte/cathode junction. Moreover, overall coverage of cathode particle surface with those inert coatings will inevitably decrease the energy density of the device.

More recent work focused on a class of fluorinated phosphate esters (Cresce and Xu, J. Electrochem, Soc., 2011, Vol. 158, A337; U.S. application Ser. No. 12/952,354) that were found to successfully increase the cycling life and efficiency of lithium-ion rechargeable battery cells.

It is therefore of significant interest to find a variety of technologies that can effectively enable 5.0 V class cathodes applied in Li ion batteries, without the aforementioned shortcomings.

It is further of significant interest to find a technology that can effectively enable the 5.0 V class cathode to be applied in Li ion batteries, while there is no major negative impact on the original electrolyte and cathode materials. Such negative impact have been exhibited in the prior art, and include but are not limited to, the failure of electrolyte to form desired interphasial chemistry on graphitic anode, the slowed Li ion kinetics and difficult electrode wetting due to high electrolyte viscosity, the increased electrolyte/cathode interphasial impedance, additional processing cost of material manufacturing, and sacrificed cathode energy density, etc.

It is therefore still of significant interest to identify such electrolytes that can stably support reversible Li ion chemistry, without those shortcomings exhibited by the prior art.

It is of further interest to identify such compounds that, once incorporated as an electrolyte component, can assist in forming a protective layer on the surface of the 5.0 V class cathodes.

It is still yet a further interest to the battery industry to identify such compounds that could serve the aforementioned purposes either as electrolyte solvent, co-solvent, solute, or both molecular and ionic additives.

### SUMMARY

The present disclosure relates to an electrochemical cell including a negative electrode; a positive electrode; an electrolyte material adapted to allow for ion passivation between the negative and positive electrodes; and an additive dispersed in the electrolyte material. The additive includes at least one oxirane compound. In an example, the electrolyte material includes a non-aqueous organic solvent present in liquid form in the absence of an electric charge. A separator can be provided that is miscible in the electrolyte material. The separator can be selected from the group consisting of a porous polyolefin separator and a gellable polymer film. The separator can be miscible with non-aqueous electrolytes with a solubility of at least 1.0 ppm.

In a further example, the additive includes at least one oxirane compound having a structure selected from the group (1)-(22) below:

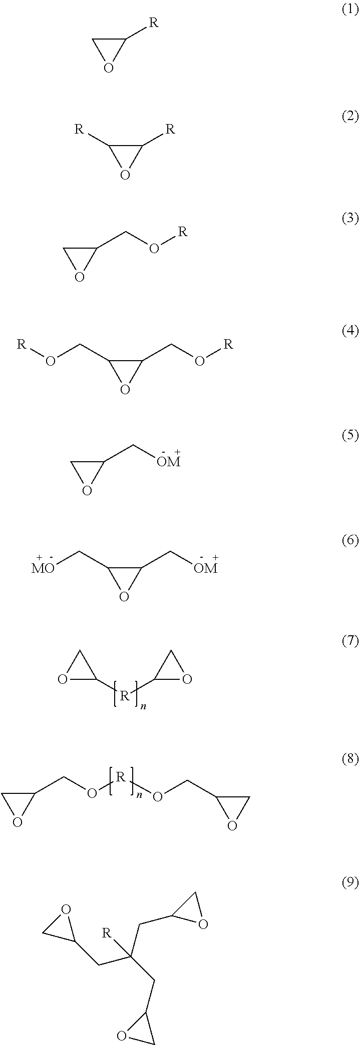

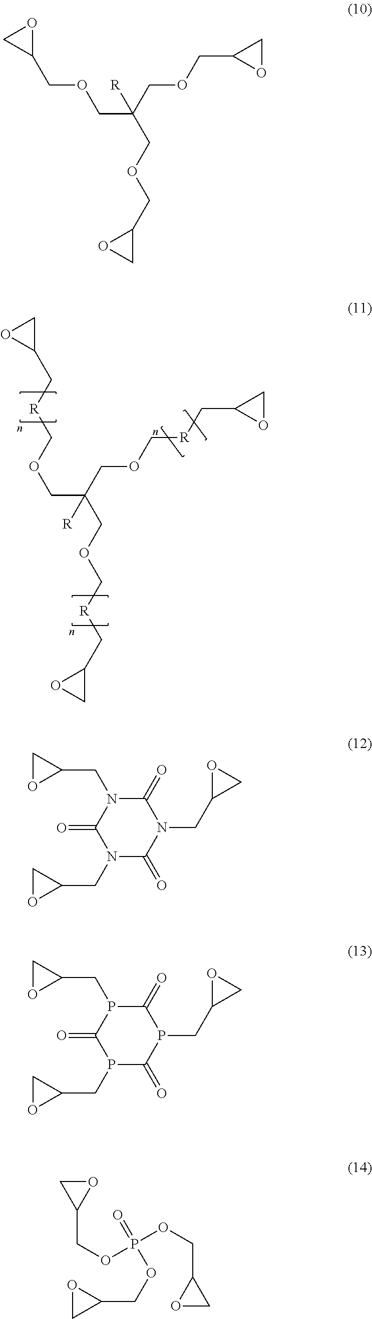

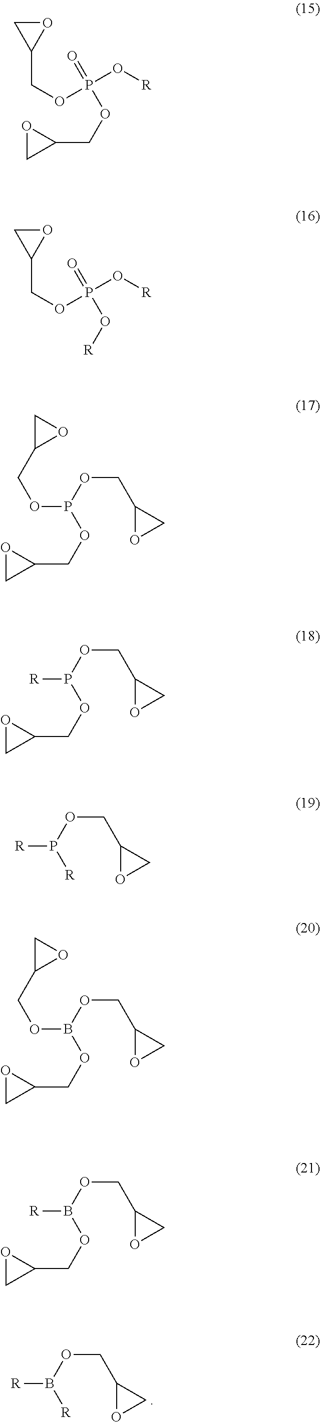

where M⁺ designates either proton (H⁺) or metal ions of various valences, comprising one of Li⁺, Na⁺, ½Mg²⁺, or ⅓Al³⁺; R designates substituents which are identical or different from each other and selected from the groups (i)-(iv) below:
(i) hydrogen, hydroxyl, or halogen containing at least one F atom;
(ii) normal or branched alkyls with a carbon number from 1 through 30, or without unsaturation;
(iii) normal or branched halogenated alkyls with carbon number ranges from 1 to 30, with or without saturations, wherein their halogenations degree varies from monohalogenation to perhalogenation; and
(iv) partially halogenated or perhalogenated normal or branched alkyls with a carbon number from 1 through 30, where the halogen substituents are identical or different and selected from the group of F, Cl, Br, I, and mixtures thereof.

In yet another example, the electrochemical cell includes a member from the group (1)-(22) above with the R substituent group including at least one of trifluoromethyl, trichloromethyl, 1,1,1-trifluoroethyl, perfluoroethyl, perfluoro-iso-propyl, 1,1,1,3,3,3,-hexafluoropropyl, perfluoro-tert-butyl, or perfluorododecayl.

In still a further example, the electrolyte material includes a co-solvent, solute or additive including one or more compounds having the structure from the group (1)-(22), further having solubility of at least 1 ppm in a nonaqueous electrolyte solvent.

The additive can be provided in sufficient amount to passivate the cathode surface and reduce decomposition occurring greater than 4.2 V vs. Li. In a further example, the additive is provided in sufficient amount to passivate the cathode surface and reduce decomposition occurring at voltages of greater than 5.0 V vs. Li.

The electrolyte material can include a non-aqueous electrolyte composition comprising one or more of: aqueous or non-aqueous solvents, alkali, ammonium, phosphonium or other metal salts, and molecular or ionic additives. In an example, the electrolyte material includes non-aqueous solvents or solvent mixtures comprising at least one of:
cyclic or acyclic carbonates and carboxylic esters selected from the group consisting: EC, PC, VC, DMC, DEC, EMC, FEC, γ-butyrolactone, methyl butyrate, ethyl butyrate, and mixtures thereof;
cyclic or acyclic ethers selected from diethylether, dimethyl ethoxglycol, tetrahydrofuran, and mixtures thereof;
cyclic or acyclic organic sulfones and sulfites selected from tetramethylene sulfone, ethylene sulfite, ethylmethyl sulfone, and mixtures thereof; and
cyclic or acyclic nitriles selected from acetonitrile, ethoxypropionitrile; and derivatives and mixtures thereof.

The electrolyte material can include a salt or salt mixture selected from the group consisting of: lithium hexafluorophosphate (LiPF₆), lithium hexafluoroarsenate (LiAsF₆), lithium tetrafluoroborate (LiBF₄), lithium perfluoroalkylfluorophosphate (LiP(CnF₂ₙ₊)ₓF₆₋ₓ, where 0≦n≦10, 0≦x≦6), lithium perfluoroalkylfluoroborate (LiB(CnF₂ₙ₊₁)ₓF₄₋ₓ, where 0≦n≦10, 0≦x≦4), lithium bis(trifluoromethanesulfonyl)imide (LiIm), lithium bis(perfluoroethanesulfonyl)imide (LiBeti), lithium bis(oxalato)borate (LiBOB), and lithium (difluorooxalato)borate (LiBF₂C₂O₄), and mixtures thereof.

In an example, the oxirane additive is present in a concentration range from 0.1 ppm to 100% with respect to the total solvent weight. In a further example, the oxirane additive is present in a concentration range from 0.3% to 1% compared to total volume of the electrolyte material.

The negative electrode can include an intercalation material having a lattice structure to accommodate any guest ions or molecules, and wherein the intercalation material is selected from the group consisting of carbonaceous materials with various degrees of graphitization, lithiated metal oxides, chalcogenides, and mixtures thereof. The positive electrode can include an active material selected from the group consisting of transition metal oxides, metalphosphates, chalcogenides, carbonaceous materials with various degrees of graphitization, and mixtures thereof. In an example, the positive and negative electrodes include materials of either high surface area for double-layer capacitance, or high pseudo-capacitance, or mixture of both.

The present disclosure further provides for an electrolyte for use in an electrochemical cell having a positive and negative electrode, the electrolyte including: an electrolyte material; and an additive dispersed in the electrolyte material, wherein the additive includes at least one oxirane compound. The oxirane compound can be selected from the group (1)-(22) as shown above.

### BRIEF DESCRIPTION OF THE DRAWINGS

FIG. 1 illustrates a schematic example of an electrochemical cell according to the present disclosure.

FIG. 2 illustrates example side by side voltage profiles of test cells with base electrolyte (left) and electrolyte with 8.5 mM glycidyl tetrafluoropropyl ether (right).

FIG. 3 shows an example comparison of differential capacity plotted vs. voltage for base electrolyte (left) and electrolyte with 0.3% glycidyl tetrafluoropropyl ether (right).

FIG. 4 shows an example comparison of capacity retention behavior of LiNi_{0.5}Mn_{1.5}O₄/Li half cells cycled in base electrolyte (dashed line) and base electrolyte with 0.3% glycidyl tetrafluoropropyl ether (solid line) under constant-current testing conditions.

### DETAILED DESCRIPTION

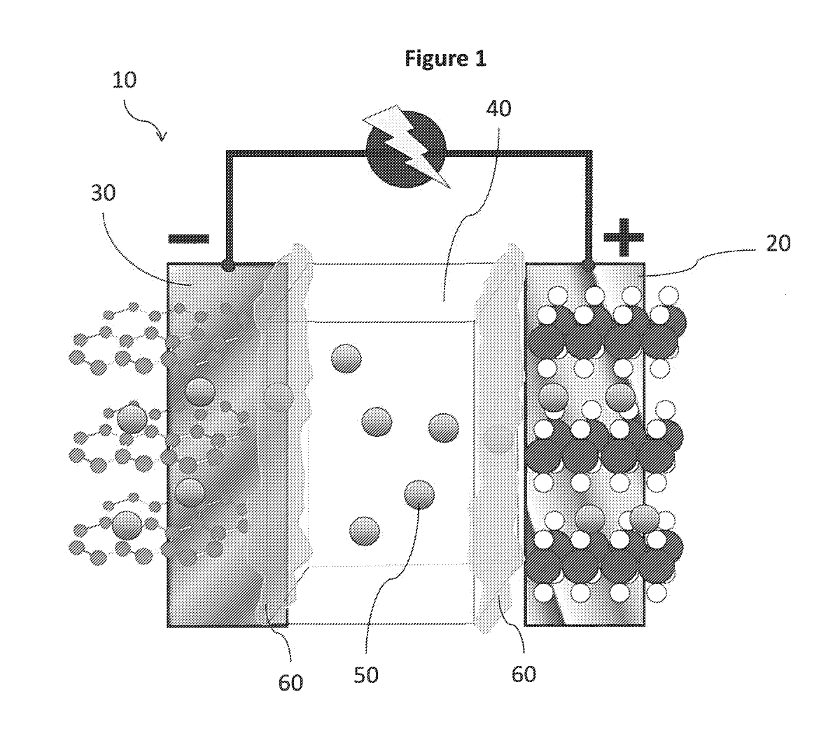

The present disclosure relates to an electrolyte for use in electrochemical cells. Referring to FIG. 1, an electrochemical cell 10 according to the present disclosure includes a pair of oppositely charged electrodes, a positive electrode 20 (cathode), and a negative electrode 30 (anode). An electrolyte material 40 is provided in intimate contact with both electrodes 20 and 30 allowing for ion 50 passivation between the electrodes. The electrolyte material 40 is typically a liquid. The present disclosure provides for an electrolyte material that further includes an oxirane additive. It is within the scope of the present disclosure to refer to the additive as having or containing at least one oxirane compound. The oxirane compound is believed to react with reactive sites on the cathode and anode surfaces forming a protective layer. This protective layer prevents decomposition at higher voltages while still allowing desired cycling of the electrochemical cell.

The interphase of the electrode and electrolyte can be referred to as an SEI (“Solid Electrolyte Interphase”) layer 60. When a voltage is applied, a film or layer 60 of solid electrolyte material is formed on the surface of the electrode. The inclusion of the oxirane additive forms a protective film at the SEI 60 thereby preventing or reducing decomposition at higher operational voltages,

### DEFINITIONS

Before describing the present disclosure in further detail, it is helpful to define the terminologies used in this disclosure so that it helps to understand the spirit of the present disclosure. It is to be understood that the definition herein is for the purpose of describing particular embodiments only, and is not intended to be limiting.

In the present disclosure, the term “organic” refers to a structure that contains hydrocarbon moieties.

In the present disclosure, the term “inorganic” refers to a structure that contains no hydrocarbon moieties.

In the present disclosure, the term “alkyl” refers to a hydrocarbon structure, with or without unsaturations, or their perhalogenated or partially halogenated derivatives.

The term “solvent” refers to molecular components of the electrolyte.

The term “solute” or “salt” refers to ionic components of the electrolyte, which will dissociate into cationic and anionic species upon dissolution in the solvents or mixture of co-solvents.

The term “co-solvents” refers to molecular components of the electrolyte whose concentrations are at least 10% by weight.

Furthermore, the term “additives” are the molecular components of the electrolyte whose concentrations are at most or lower than 10% by weight.

The term “molecular” refers to compounds that cannot be dissociated into any ionic species in non-aqueous electrolyte solvents.

The term “ionic” refers to compounds that can be dissociated into a cation species that bears positive charge and an anion species that bears equal but negative charge in non-aqueous electrolyte solvents.

It is desirable to develop electrochemical cells that can reversibly store and release electricity at voltages above 4.5 V.

Particularly, it is desirable to develop electrochemical cells that can reversibly store and release electricity at voltages in the neighborhood of or above 5.0 V.

Still more particularly, it is desirable to develop the aforementioned electrochemical cells, which include, but are not limited to, rechargeable batteries that are based on Li ion chemistry, or electrochemical double-layer capacitors that comprise high surface area electrodes.

Yet still more particularly, it is desirable to develop the aforementioned electrochemical cells based on Li ion chemistry, which comprise of 5.0 V class cathode materials such as, but are not limited to, spinet metal oxide LiNi_{0.5}Mn_{1.5}O₄ or olivine phosphate LiCoPO₄, and materials of other chemical natures.

Even yet still more particularly, it is desirable to develop the aforementioned electrochemical cells based on electrochemical double layer capacitance, which include high surface area materials as electrodes, such as, but are not limited to, graphite, activated carbon, aligned or random carbon nanotubes, various aerogels and materials of other chemical natures.

Further yet, it is desirable to formulate electrolyte materials and compositions that would enable the aforementioned electrochemical cells.

Even further yet, it is desirable to identify and develop compounds that, once incorporated into electrolytes either as electrolyte solvent, co-solvent, solute or molecular and ionic additives, would assist in stabilizing the electrolyte against oxidative decompositions, and reduce negatively impacting the properties and performances of the electrochemical cells.

It is an objective of the present disclosure to identify and develop such electrolyte compounds having an oxirane additive.

It is another objective of the present disclosure to develop the electrolyte compositions and solutions utilizing such oxirane compounds either as solvent, co-solvent, solute, or molecular and ionic additives. Electrolytes so formulated will have a wider electrochemical stability window, and are capable of supporting electrochemical processes occurring at high potentials without persistent degradation.

It is still another objective of the present disclosure to assemble electrochemical cells utilizing such electrolyte solutions. Examples of electrochemical cells include, but are not limited to, rechargeable batteries or electrochemical double-layer capacitors that have been described above. The cells thus developed should deliver superior performances as compared with the state-of-the-art technologies in terms of the energy density and energy quality.

These and additional objectives of the disclosure are accomplished by adopting one or more compounds either as solvent, co-solvent, solute, or molecular and ionic additives in the non-aqueous electrolytes.

More particularly, these and additional objectives of the disclosure are accomplished by adopting one or more compounds in the non-aqueous electrolytes, which are soluble in the non-aqueous, organic electrolyte solvents to certain concentrations.

Still more particularly, these compounds, upon dissolution in the non-aqueous electrolytes, will form desirable interphasial chemistry on cathode surfaces. The compounds, upon dissolution in the non-aqueous electrolytes, will either form desirable interphasial chemistry on anode surfaces, or will not negatively impact the other electrolyte components to form desirable interphasial chemistry on anode surfaces. With the electrolyte solutions including these compounds either as solvent, co-solvent, solute, or molecular and ionic additives in the non-aqueous electrolytes, all the said objectives can be achieved.

Even still more particularly, the present disclosure relates to the compounds that can be incorporated into electrolytes as electrolyte co-solvents, electrolyte additives, or electrolyte solutes, the result of such incorporation being that the electrolytes can support the reversible Li ion intercalation/de-intercalation chemistry at potentials above 4.5 V. Still more particularly, the present disclosure relates to compounds that can be incorporated into the electrolyte as electrolyte co-solvents, electrolyte additives, or electrolyte solutes, which, upon the initial charging of the cathode, decompose sacrificially to form a passivation film. This passivation film prevents sustaining decomposition of electrolyte components but does not hinder the reversible Li ion intercalation/de-intercalation chemistry at potentials above 4.5 V.

In an example the present disclosure is intended to enable the use of high voltage cathode materials in rechargeable lithium-ion batteries. Current state-of-the-art lithium-ion batteries operate with a maximum voltage of 4.2 V, in part limited by the electrochemical stability of the electrolyte itself. A lithium-ion battery operating at voltage higher than 4.2 V will have a higher energy density and will deliver higher-quality direct electric current. State-of-the-art electrolytes, comprised primarily of organic carbonate esters, decompose at electrode potentials below 4.5 V against the cathode surface, causing persistent and parasitic capacity fading accompanied with increasing internal cell impedance.

In a further example, high voltage cathodes and cathode materials include, but are not limited to, transition-metal oxides with spinel lattice structures, metal fluorides, metal pyrophosphates, and metal phosphates with olivine structures.

In a further example, the compounds used in the oxirane electrolytes of the present disclosure go beyond the battery application and could benefit any electrochemical devices that operate at high potentials. The presence of the compounds in the electrolyte can stabilize the highly oxidizing surface of the positive electrode and hence enable new chemistry that is otherwise not achieved with the current state-of-the-art electrolyte technology. Such electrochemical devices include, but are not limited to, rechargeable and non-rechargeable batteries, double layer capacitors, pseudo-capacitors, electrolytic cells, fuel cells, etc.

In an example, batteries or electrochemical devices include a pair of electrodes an electrolyte material. These electrochemical devices can include, but are not limited to: an anode, a cathode, and an electrolyte adapted to allow for passing of Li-ion between the two electrodes. An anode can include materials selected from the group consisting of lithium or other alkali metals, alloys of lithium or other alkaline metals, intercalation hosts such as layered structured materials of graphitic, carbonaceous, oxides or other chemical natures, non-intercalating hosts of high surface area or high pseudo capacitance, and the like. A cathode can include materials selected from the group consisting of an intercalation host based on metal oxides, phosphates, fluorides or other chemical natures, or non-intercalating hosts of high surface area or high pseudo-capacitance, and the like.

In an example, electrolytes according to the present disclosure include: (a) one or more electrolyte solutes with various cations and anions; (b) a solvent or a mixture of solvents based on organic carbonates or other compounds; and (c) one or more oxirane containing additives.

Table 1 is a list of compounds 1-22 that oxirane compounds suitable to be included in additives for electrolytes of the present disclosure. They contain various chemical moieties to serve various purposes but always contain the triangular oxirane functionality. The oxirane-based or oxirane-containing additive found in the electrolyte material can include compounds of the present disclosure which are constructed on the basis of the molecules as shown in structures 1 through 22 (Table 1), where:

M⁺ designates either proton (Fr) or metal ions of various valences, examples of which include, but are not limited to, Li⁺, Na⁺, ½Mg²⁺, ⅓Al³⁺, etc.;

R_{F}¹, R_{F}² and R_{F}³ designate normal or branched halogenated alkyls with carbon number ranges from 1 to 30, with or without saturations;

R_{F}¹, R_{F}² and R_{F}³ can be identical or different from each other, and their halogenations degree varies from monohalogenation to perhalogenation;

Examples of R_{F}¹, R_{F}² and R_{F}³ include, but are not limited to, trifluoromethyl, trichloromethyl, 1,1,1-trifluoroethyl, perfluoroethyl, perfluoro-iso-propyl, 1,1,1,3,3,3, hexafluoropropyl, perfluoro-tert-butyl, perfluorododecayl, etc.

TABLE 1
Structures of Compounds

| | |
|---|---|
| 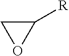 | (1) |
| 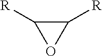 | (2) |
| 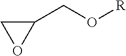 | (3) |
| 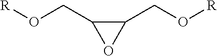 | (4) |
| 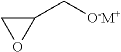 | (5) |
| 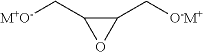 | (6) |
| 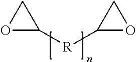 | (7) |
| 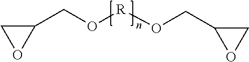 | (8) |
| 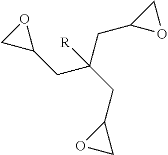 | (9) |
| 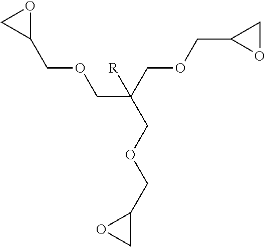 | (10) |
| 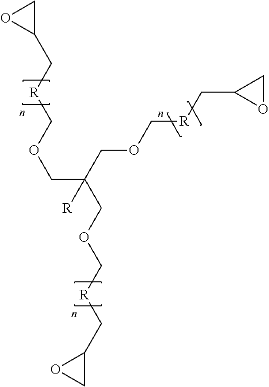 | (11) |
| 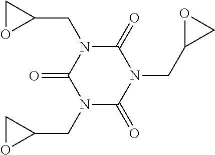 [SMILES: O=c1n(CC2CO2)c(=O)n(CC2CO2)c(=O)n1CC1CO1] | (12) |
| 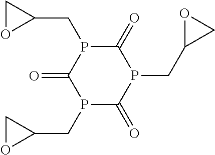 [SMILES: O=c1p(CC2CO2)c(=O)p(CC2CO2)c(=O)p1CC1CO1] | (13) |
| 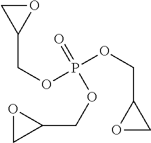 [SMILES: O=P(OCC1CO1)(OCC1CO1)OCC1CO1] | (14) |
| 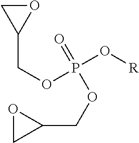 | (15) |
| 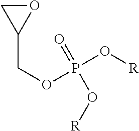 | (16) |
| 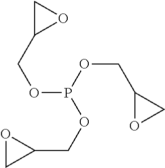 [SMILES: C1OC1COP(OCC1CO1)OCC1CO1] | (17) |
| 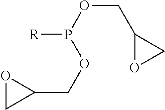 | (18) |
| 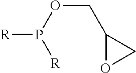 | (19) |
| 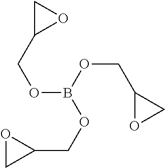 [SMILES: C(OB(OCC1CO1)OCC1CO1)C1CO1] | (20) |
| 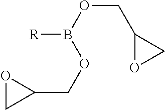 | (21) |
| 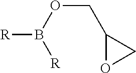 | (22) |

These compounds can be dissolved in typical non-aqueous electrolyte solvent or mixture of solvents. The compounds can serve in the electrolyte either as major solvents, or co-solvents at contents above 10% by weight, or as salts at concentrations as high as 3.0 m, or as additives at concentrations below 10% by weight.

In an example, the above-mentioned typical non-aqueous electrolyte solvents include, but are not limited to, organic carbonate esters such as ethylene carbonate (EC), propylene carbonate (PC), dimethylcarbonate (DMC), ethylmethylcarbonate (EMC), diethylcarbonate (DEC), monofluoro ethylene carbonate (FEC), et cetera; or organic acid esters such as alkyl carboxylates, lactones, et cetera; and inorganic acid esters such as alkyl sulfonates, alkyl sulfurates, alkyl phosphonates, alkyl nitrates, and et cetera; or dialkyl ethers that are either symmetrical or unsymmetrical, or alkyl nitriles.

The above-mentioned typical no aqueous electrolytes also include electrolyte solutes that are based on a cation and an anion. The cation selections include but are not limited to, alkali metal salts such as lithium (Li), sodium (Na), potassium (K), etc., or alkali earth metal salts such as beryllium (Be), magnesium (Mg), calcium Ca), etc., or tetraalkylammonium or phosphonium (R₄N, R₄P); whereas the anion selections include but are not limited to (PF₆), hexatluoroarsenate (AsF₆), tetrafluoroborate (BF₄), perfluoroalkyltluorophosphate (PFₓR_{F(6-x)}), perfluoroalkylfluoroborate (BFₓR_{F(4-x)}), bis(trifluoromethanesulfonyl)imide ((CF₃SO₂)₂N), bis(perfluoroethanesulfonyl)imide ((CF₃CF₂SO₂)₂N), bis(oxalato)borate ((C₂O₄)₂B), (difluorooxalato)borate (C₂O₄FB), The salts are selected by combining these cation and anions.

In an example, the compounds in the additives of the electrolytes of the present disclosure include at least one fluorine in the structure.

Example compounds of the present disclosure can be selected from group consisting of: Glycidyl 2,2,3,3-tetrafluoropropyl ether (GTFPE), [2,2,3,3-tetrafluoro-2-(heptafluoropropoxy)propyl]oxirane (FPPO), and trimethylolpropane triglycidyl ether (TMPTE).

The present disclosure further relates to the fabrication of electrochemical devices that are filled with the electrolyte solution discussed herein. These devices include, but are not limited to, (i) lithium batteries with lithium metal cells as anode, and various transition metal oxides, phosphates and fluorides as cathode; (ii) Li ion batteries with carbonaceous such as graphitic, carbon nanotube, graphene as anode, or non-carbonaceous such as titania or other Li⁺ intercalating hosts as anode, and various transition metal oxides, phosphates and fluorides as cathode; (iii) electrochemical double-layer capacitors with both carbonaceous and non-carbonaceous electrodes of high surface area or high pseudo-capacitance; and (iv) dual intercalation cells in which both cation and anion intercalate simultaneously into lattices of anode and cathode materials of either carbonaceous or non-carbonaceous natures, respectively.

These electrochemical devices containing the electrolyte solutions as disclosed in the present disclosure can enable high voltage rechargeable chemistries that would be otherwise difficult or unachievable with the state-of-the-art electrolyte technologies.

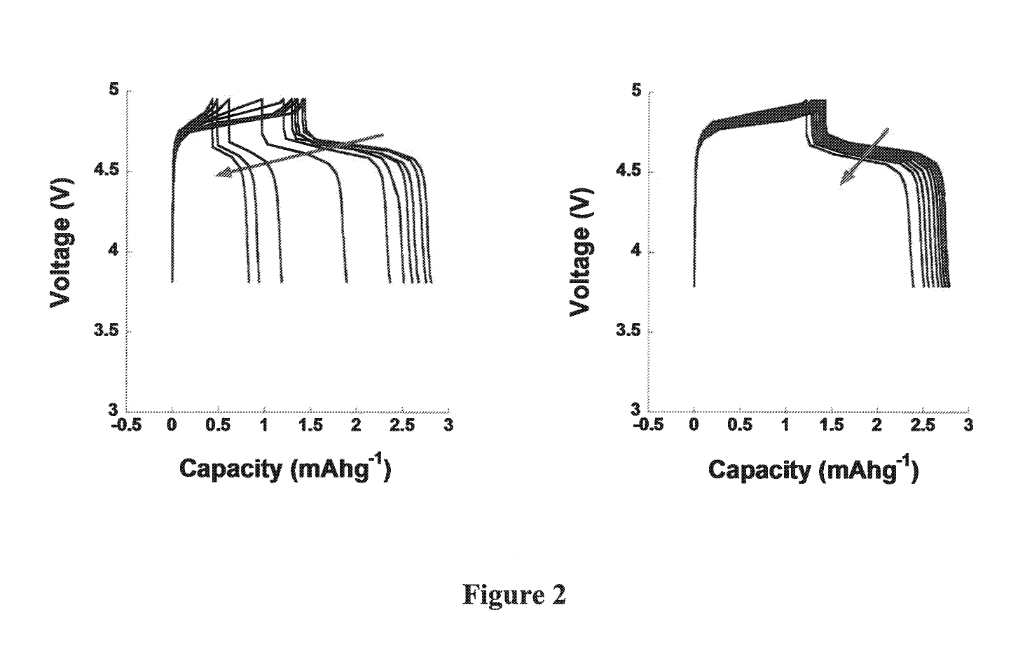

Referring to the Figures, FIG. 2 illustrates example side by side voltage profiles of test cells with base electrolyte (left) and electrolyte with 8.5 mM glycidyl tetrafluoropropyl ether (right). Both cells use a standardized LiNi_{0.5}Mn_{1.5}O₄ cathode and lithium metal counter/reference electrode. The plots show cycle 10-100 for each cell in steps of 10. 0.3% of glycidyl tetrafluoropropyl ether dissolved in the base electrolyte (right) significantly reduces capacity loss during cycling. Plots of cycle life trend in the direction of the arrow, early cycles have higher capacity than subsequent cycles. The addition of 0.3% glycidyl tetrafluoropropyl ether has noticeably reduced the loss of charge/discharge capacity during the course of cycling compared to the base electrolyte.

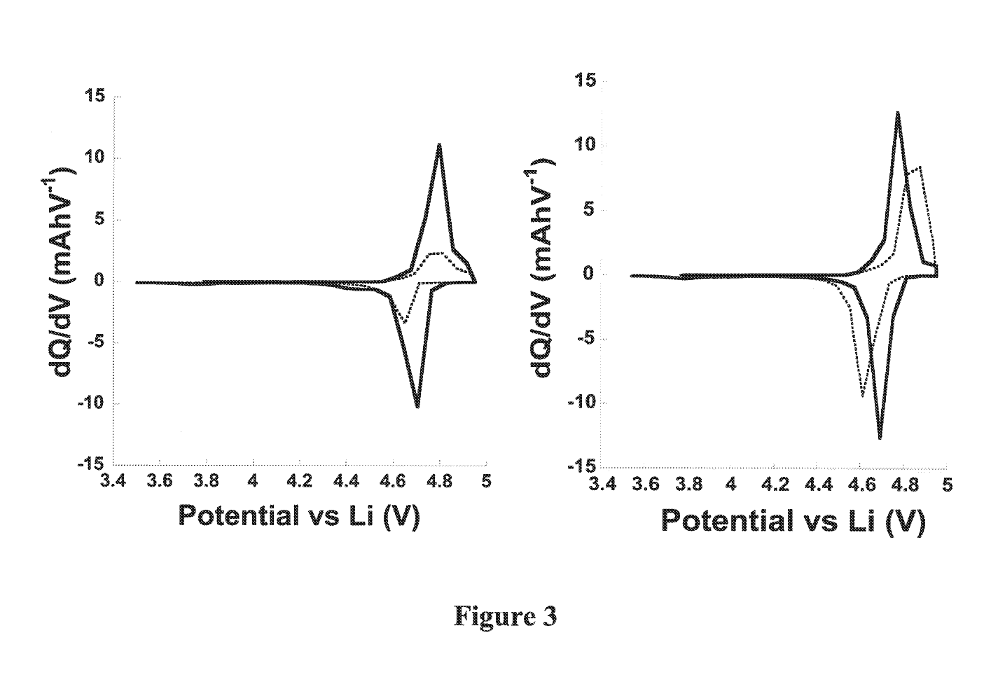

FIG. 3 shows a side by side comparison of differential capacity plotted vs. voltage for base electrolyte (left) and electrolyte with 0.3% glycidyl tetrafluoropropyl ether (right). Each plot shows the 10^{th} (solid line) and 100^{th} (dotted line) cycles.

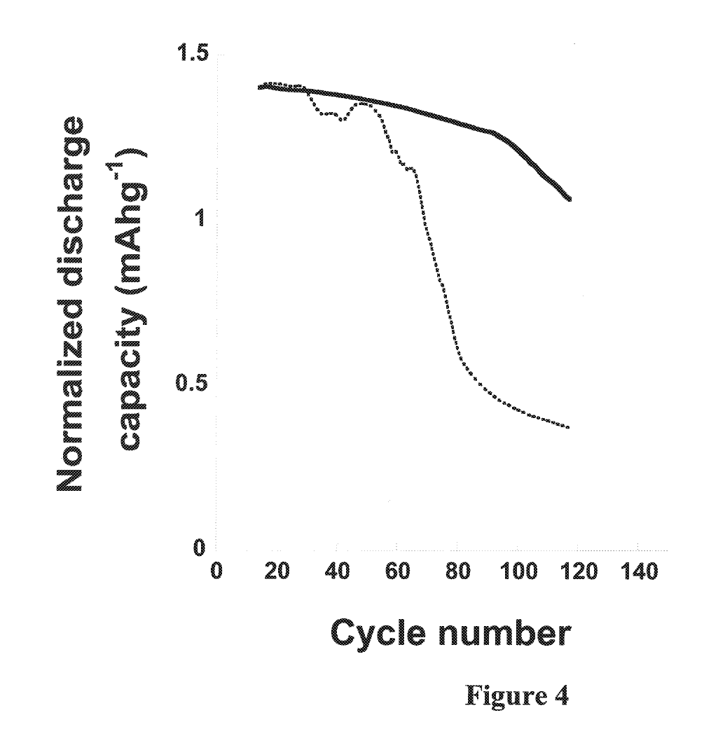

FIG. 4 shows a comparison of the capacity retention behavior of LiNi_{0.5}Mn_{1.5}O₄/Li half cells cycled in base electrolyte (dashed line) and base electrolyte with 0.3% glycidyl tetrafluoropropyl ether (solid line) under constant-current testing conditions. As in FIG. 2 and FIG. 3, the cell containing the modified electrolyte significantly exceeds the base electrolyte in performance and useful life.

Having described the present disclosure, the following examples are given to illustrate specific applications including the best mode now known to perform the disclosure. They are intended to provide those of ordinary skills in the art with a complete disclosure and description of how make and use the solvents and additives of the present disclosure. These specific examples are not intended to limit the scope of the disclosure described in this application.

### Examples

### Formulation of Electrolyte Solutions

This example summarizes a general procedure for the preparation of electrolyte solutions including the solvents, solutes and oxirane additives of this disclosure, whose structures have been listed in Table 1. Both the concentration of the lithium salts, the co-solvent ratios, and the relative ratios between the additives to solvents can be varied according to needs.

The salts selected include, but are not limited to, LiPF₆, LiAsF₆, LiBF₄, LiP(CₙF₂ₙ₊₁)ₓF₆, (0≦n≦10, 0≦x≦6), LiB(CₙF₂ₙ₊₁)ₓF₄₋ₓ (0≦n≦10, 0≦x≦4), LiIm, LiBeti, LiBOB, and LiBF₂C₂O₄, triethylmethylammonium (Et₃MeNPF₆), any one or more of the compounds whose structures were listed in Table 1, and mixtures thereof.

The solvents selected include, but are not limited to, EC, PC, DMC, DEC, EMC, FEC, CF₃-EC, any one or more of the compounds whose structures were listed in Table 1, and mixtures thereof.

The oxirane additives selected include any one or more of the compounds whose structures were listed in Table 1, and mixtures thereof. The resultant electrolyte solution should contain at least one of those compounds that are disclosed in the present disclosure.

In an example, 10 g base electrolyte solution of 1.2M LiPF₆/EC/EMC (30:70) was made in glovebox by mixing 3 g EC and 7 g EMC followed by adding 1.823 g LiPF₆. The aliquots of the base electrolyte solution was then taken to be mixed with various amount of glycidyl 2,2,3,3-tetrafluoropropyl ether. The concentration of glycidyl 2,2,3,3-tetrafluoropropyl ether ranges from 1 mM up to 100 mM.

In a similar example, 10 g base electrolyte solution of 1.2M LiPF₆/FEC/EC/EMC (15:15:70) was made in glovebox by mixing 1.5 g FEC, 1.5 g EC and 7.0 g EMC followed by adding 1.823 g LiPF₆, and aliquots of the base electrolyte solution was then taken to be mixed with various amounts of [2,2,3,3-tetrafluoro-2-(heptafluoropropoxy)propyl]oxirane. The concentration of [2,2,3,3-tetrafluoro-2-(heptafluoropropoxy)propyl]oxirane ranges from 1 mM up to 100 mM.

In another example, 1000 g base electrolyte solution of 1.0 m LiPF₆/Tris(1,1,1,3,3,3-hexafluoroisopropyl)phosphate/EC/EMC (15:15:70) was made in glovebox by mixing 150 g Tris(1,1,1,3,3,3-hexafluoroisopropyl)phosphate, 150 g EC and 700 g EMC followed by adding 151.9 g LiPF₆.

In another example, the electrolyte solutions with other compounds at varying concentrations were also made with trimethylolpropane triglycidyl ether, glycidyl 2,2,3,3,4,4,5,5-octafluoropentyl ether, 1,4-butanediol diglycidyl ether, polyethylene glycol diglycidyl ether, polypropylene glycol diglycidyl ether, et ceteras.

With purpose of illustrating only and no intention to be limiting, Table 2 listed some typical electrolyte solutions prepared and tested. It should be noted that the compositions disclosed in Table 2 may or may not be the optimum compositions for the electrochemical devices in which they are intended to be used, and they are not intended to limit the scope of the present disclosure. Table 2 summarizes selected electrolyte solutions formulations by using the base electrolyte and the compounds disclosed in the present disclosure as either an electrolyte solvent, co-solvent, solute, or additives.

TABLE 2
Electrolyte Solutions with Oxirane-Based Additives

| Salt | | |
|---|---|---|
| Concentration | Solvent Ratio | Additive Concentration |
| (M) | (by Weight) | (by Weight) |
| LiPF₆ (1.2) | EC/EMC (30:70) | 0.3% Glycidyl tetrafluoropropyl |
| | | ether |
| LiPF₆ (1.2) | EC/EMC (30:70) | 0.6% Glycidyl octafluoropentyl |
| | | ether |
| LiPF₆ (1.2) | EC/EMC (30:70) | 0.3% Glycidyl octafluoropentyl |
| | | ether |
| LiPF₆ (1.0) | EC/EMC (30:70) | 0.1% Trimethylolpropyl triglycidyl |
| | | ether |
| LiBF₄ (1.0) | FEC (100) | 0.1% Glycidyl tetrafluoropropyl |
| | | ether |
| LiBOB (1.0) | EC/γBL/ | 1% Trimethylolpropyl triglycidyl |
| | EMC/MB | ether |
| | (15:15:40:30) | |
| Et₃MeNPF₆ | EC/EMC (30:70) | 1% [2,2,3,3-tetrafluoro-2- |
| (2.0) | | (heptafluoropropoxy)propyl]oxirane |
| LiPF₆ (1.0) | EC/FEC/EMC | 0.5% Glycidyl tetrafluoropropyl |
| | (20:60:20) | ether |

### Fabrication of an Electrochemical Cell

This example summarizes the general procedure of the assembly of electrochemical cell. These electrochemical cells include Li ion cell, double layer capacitor, or dual intercalation cell. Typically, a piece of CELGARD polypropylene separator was sandwiched between an anode and a cathode. The cell was then activated by soaking the separator with an electrolyte solutions as prepared in the examples above, and sealed with appropriate means. All above procedures were conducted under dry atmospheres in either glovebox or dryroom.

With the present disclosure having been described in general and in details and the reference to specific embodiments thereof, it will be apparent to one ordinarily skilled in the art that various changes, alterations, and modifications can be made without departing from the spirit and scope of the present disclosure and its equivalents as defined by the appended claims.

What is claimed is:

1. An electrochemical cell comprising:
a negative electrode;
a positive electrode;
an electrolyte material adapted to allow for ion passivation between the negative and positive electrodes;
an additive dispersed in the electrolyte material;
wherein the additive includes at least one oxirane compound.

2. The electrochemical cell of claim 1 further comprising a Lithium ion source for Lithium ion passivation between the negative and positive electrodes.

3. The electrochemical cell of claim 1 wherein the electrolyte material further comprises a non-aqueous organic solvent present in liquid form in the absence of an electric charge.

4. The electrochemical cell of claim 1 further comprising a separator miscible in the electrolyte material, wherein the separator is selected from the group consisting of a porous polyolefin separator and a gellable polymer film.

5. The electrochemical cell of claim 4 wherein the separator is miscible with non-aqueous electrolytes with a solubility of at least 1.0 ppm.

6. The electrochemical cell of claim 1 wherein the additive comprises at least one oxirane compound having a structure selected from the group (1)-(22) below: 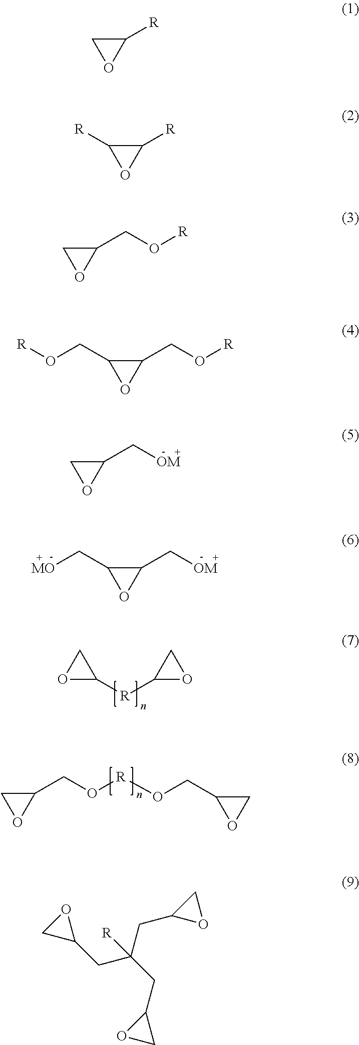 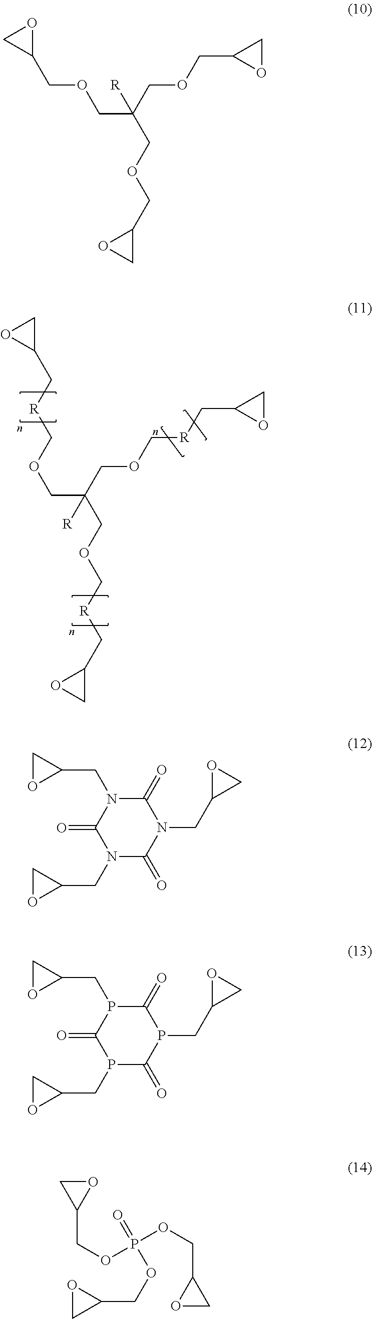 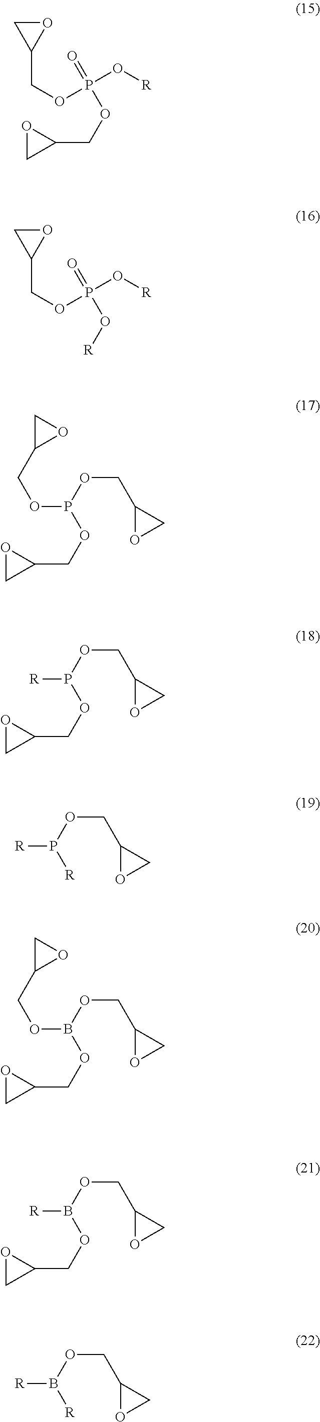
wherein:
M⁺ designates either proton (H⁺) or metal ions of various valences, comprising one of Li⁺, Na⁺, ½Mg²⁺, or ⅓Al³⁺;
R designates substituents which are identical or different from each other and selected from the groups (i)-(iv) below:
(i) hydrogen, hydroxyl, or halogen containing at least one F atom;
(ii) normal or branched alkyls with a carbon number from 1 through 30, or without unsaturation;
(iii) normal or branched halogenated alkyls with carbon number ranges from 1 to 30, with or without saturations, wherein their halogenations degree varies from monohalogenation to perhalogenation; and
(iv) partially halogenated or perhalogenated normal or branched alkyls with a carbon number from 1 through 30, where the halogen substituents are identical or different and selected from the group of F, Cl, Br, I, and mixtures thereof.

7. The electrochemical cell of claim 6 wherein the R substituent group includes at least one of: trifluoromethyl, trichloromethyl, 1,1,1-trifluoroethyl, perfluoroethyl, perfluoro-iso-propyl, 1,1,1,3,3,3,-hexafluoropropyl, perfluoro-tort-butyl, or perfluorododecayl.

8. The electrochemical cell of claim 6 wherein the electrolyte material comprises a co-solvent, solute or additive including one or more compounds having the structure from the group (1)-(22), further having solubility of at least 1 ppm in a nonaqueous electrolyte solvent.

9. The electrochemical cell of claim 1 wherein the additive is provided in sufficient amount to passivate the cathode surface and reduce decomposition occurring greater than 4.2 V vs, Li.

10. The electrochemical cell of claim 1 wherein the additive is provided in sufficient amount to passivate the cathode surface and reduce decomposition occurring at voltages of greater than 5.0 V vs. Li.

11. The electrochemical cell of claim 1 wherein the electrolyte material includes a non-aqueous electrolyte composition comprising one or more of: aqueous or non-aqueous solvents, alkali, ammonium, phosphonium or other metal salts, and molecular or ionic additives.

12. The electrochemical cell of claim 1 wherein the electrolyte material includes non-aqueous solvents or solvent mixtures comprising at least one of:
cyclic or acyclic carbonates and carboxylic esters selected from the group consisting: EC, PC, VC, DMC, DEC, EMC, FEC, γ-butyrolactone, methyl butyrate, ethyl butyrate, and mixtures thereof;
cyclic or acyclic ethers selected from diethylether, dimethyl ethoxglycol, tetrahydrofuran, and mixtures thereof;
cyclic or acyclic organic sulfones and sulfites elected from tetramethylene sulfone, ethylene sulfite, ethylmethyl sulfone, and mixtures thereof; and
cyclic or acyclic nitriles selected from acetonitrile, ethoxypropionitrile; and derivatives and mixtures thereof.

13. The electrochemical cell of claim 1 wherein the electrolyte material comprises salt or salt mixture selected from the group consisting of: lithium hexafluorophosphate (LiPF₆), lithium hexafluoroarsenate (LiAsF₆), lithium tetrafluoroborate (LiBF₄), lithium perfluoroalkylfluorophosphate (LiP(CnF₂ₙ₊₁)ₓF₆₋ₓ, where 0≦n≦10, 0≦x≦6), lithium perfluoroalkylfluoroborate (LiB(CnF₂ₙ₊₁)ₓF₄₋ₓ, where 0≦n≦10, 0≦x≦4), lithium bis(trifluoroethanesulfonyl)imide (LiIm), lithium bis(perfluoroethanesulfonyl)imide (LiBeti), lithium bis(oxalato)borate (LiBOB), and lithium (difluorooxalato)borate (LiBF₂C₂O₄) and mixtures thereof.

14. The electrochemical cell of claim 1 wherein the oxirane additive is present in a concentration range from 0.1 ppm to 10% with respect to the total solvent weight.

15. The electrochemical cell of claim 1 wherein the oxirane additive is present in a concentration range from 0.3% to 1% compared to total volume of the electrolyte material.

16. The electrochemical cell of claim 1 wherein the negative electrode comprises an intercalation material having a lattice structure to accommodate any guest ions or molecules, and wherein the intercalation material is selected from the group consisting of carbonaceous materials with various degree of graphitization, lithiated metal oxides, chalcogenides, and mixtures thereof.

17. The electrochemical cell of claim 1 wherein the positive electrode comprises an active material selected from the group consisting of transition metal oxides, metalphosphates, chalcogenides, carbonaceous materials with various degree of graphitization, and mixtures thereof.

18. The electrochemical cell of claim 1 wherein the positive and negative electrodes comprise materials of either high surface area for double-layer capacitance, or high pseudo-capacitance, or mixture of both.

19. An electrolyte for use in an electrochemical cell having a positive and negative electrode, the electrolyte comprising:
an electrolyte material; and
an additive dispersed in the electrolyte material, wherein the additive includes at least one oxirane compound.

20. The electrolyte of claim 19 wherein the additive comprises at least one oxirane compound having a structure selected from the group (1)-(22) below: 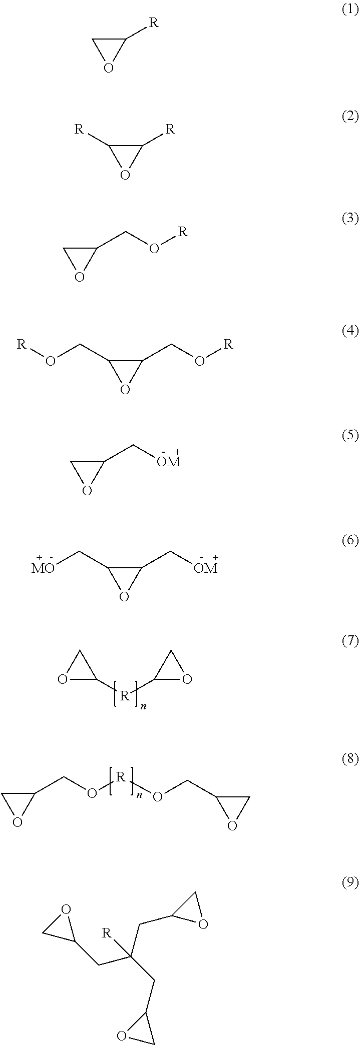 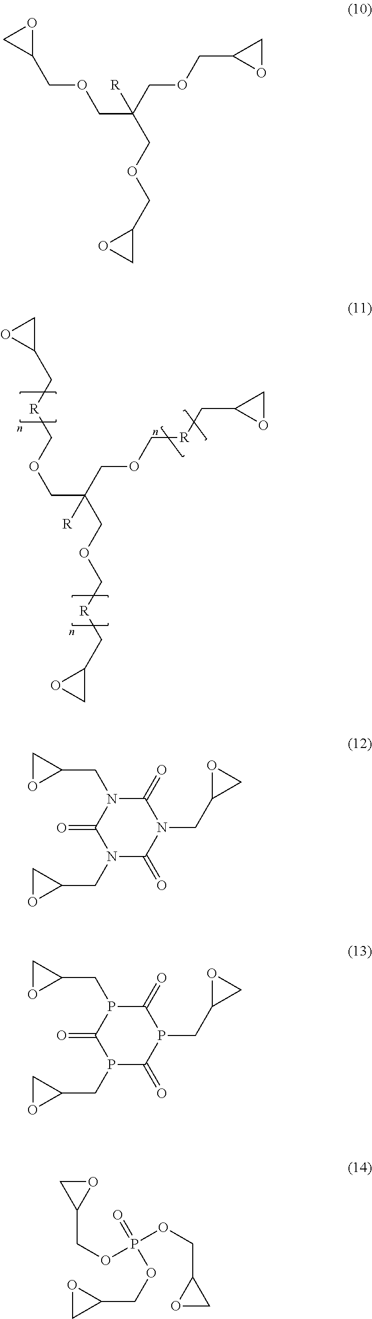 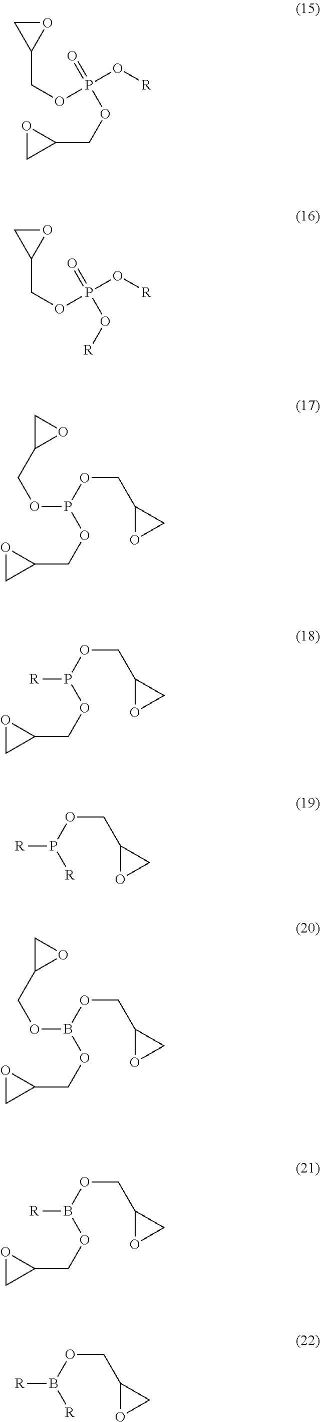
wherein:
M⁺ designates either proton (H⁺) or metal ions of various valences, comprising one of Li⁺, Na⁺, ½Mg²⁺, or ⅓Al³⁺;
R designates substituents which are identical or different from each other and selected from the groups (i)-(iv) below:
(i) hydrogen, hydroxyl, or halogen containing at least one F atom;
(ii) normal or branched alkyls with a carbon number from 1 through 30, or without unsaturation;
(iii) normal or branched halogenated alkyls with carbon number ranges from 1 to 30, with or without saturations, wherein their halogenations degree varies from monohalogenation to perhalogenation; and
(iv) partially halogenated or perhalogenated normal or branched alkyls with a carbon number from 1 through 30, where the halogen substituents are identical or different and selected from the group of F, Cl, Br, I, and mixtures thereof.
